(19) United States
(12) Patent Application Publication
(10) Pub. No.: US 2016/0027227 A1
(43) Pub. Date: Jan. 28, 2016

(54) CUSTOM CREDENTIALING

(71) Applicant: Vendor Credentialing Service LLC (VCS), Houston, TX (US)

(72) Inventors: Garry Wayne Kyle, JR., Flower Mound, TX (US); Troy Kyle, Tomball, TX (US); Cale Wenmohs, Katy, TX (US); Matthew Read, Spring, TX (US); Vishal Yadav, Houston, TX (US); Kristine Tannert, Houston, TX (US); Rick Pleczko, Houston, TX (US); Brittany Calderon, Magnolia, TX (US); Wayne Washburn, Houston, TX (US)

(21) Appl. No.: 14/519,876

(22) Filed: Oct. 21, 2014

Related U.S. Application Data
(60) Provisional application No. 62/029,187, filed on Jul. 25, 2014.

(51) Int. Cl. G07C 9/00; G06F 17/30

(52) U.S. Cl. CPC G07C 9/00166; G06F 17/30339; G06F 17/30539

(57) ABSTRACT

In one example, credentialing method involving a credentialing provider and a client comprising the step of establishing one or more custom credential categories for an entity.

### RELATED APPLICATION

This application claims priority under 35 U.S.C. §119 to U.S. Provisional Application No. 62/029,187, entitled “Customizable Credentialing Software,” by the same inventors, filed 25 Jul. 2014 (Atty. Docket No.: VCS2002PSP), the contents of which are herein incorporated by reference in their entirety.

### BACKGROUND

1. Technical Field

Embodiments of the subject matter disclosed herein generally relate to methods and systems for ensuring that only entities (whether animate or inanimate) meeting pre-set criteria are allowed to enter an environment that could be compromised by an entity entering that environment that does not meet the pre-set criteria. In this regard, one embodiment of the present invention is directed to custom credentialing, where any entity desiring entry to (or continued presence in) a heath care facility must first meet certain pre-set credentials before being allowed to enter (or remain in) that facility.

2. Discussion of the Background

The modern-day explosion in population, disease, harmful substances, dangerous environments, contamination, and crime has given rise to the field of credentialing, which generally concerns taking steps to ensure that people and things are not allowed to go places or encounter things they should not. One example is the health care field. There, a host of environments exist in which it is important that only authorized personnel and/or devices (or other things) be allowed to interact in proximity to one another. In other words, only personnel and/or a device that meets a common set of pre-established credentials will be allowed to interact within proximity to one another.

As one non-limiting example, take vendors (e.g., service or product providers) who wish to enter a health care facility (e.g., a hospital, doctor's office, or emergency care facility) to sell, service, or otherwise offer their third-party offerings to the operators of the health care facility. In the past, these individuals may have been allowed to enter the facility uninterrupted, without any admittance criteria or standards. The health and safety risks associated with such uninhibited or “free” access are obvious and, as such, now often are prohibited by Federal, state, local, or best practices guidelines.

As referenced above, the process of controlling vendor access to facilities is called credentialing. In the health care environment, one method of credentialing requires vendors to approach a designated screening representative at each health care facility the vendor visits, so that the screening representative can invoke that facility's established protocol for deciding whether to allow the vendor access to the facility. This method is disfavored due to its burden on personnel, necessary training, consequential front-office congestion, lack of contemporaneous access to updated and/or accurate vendor data, and the costs associated therewith.

Another credentialing option is for the health care facility to use the services of an outside, third-party credentialing provider. One well-known and often-used provider is VCS, Inc. (www.vcsdatabase.com).

These credentialing providers require vendors to register with them so that the credentialing provider (instead of the health care facility) performs at least the same credentialing the health care facility would, but the credentialing is done off-site from the health care facility and in a manner that each individual vendor's credentials are investigated, verified against the credentials mandated by each pertinent/participating health care facility, and stored for future use, updating, and network access by the credentialing provider. After a vendor is approved, the credentialing provider gives the qualified/credentialed vendor a badge that typically contains a bar code and possibly other identifying information (such as a photograph), which the vendor uses to authenticate himself in two primary respects when he enters a participating health care facility.

First, the bar code on the vendor's badge can be scanned at a kiosk or other scanning facility in the lobby of the health care facility. In the instance of a kiosk, it typically is computer-implemented and possesses either local or networked access to a database maintained by the credentialing provider, such that the kiosk uses the bar code to identify the vendor and then access and examine the associated vendor's credentials relative to those mandated by the pertinent health care facility. Through this computerized process, the kiosk either approves or denies the vendor's access to the health care facility. This approval process can entail either the printing of an entrance sticker (to be worn by the vendor), open a locked door, or provide other authorized passage to the facility.

Second, as mentioned above, while the badge also may provide photo identification, in those instances in which the kiosk prints an entrance sticker, the kiosk also may print an additional code on the sticker. This additional code provides opportunity for on-the-spot verification by facility personnel as an added security measure after the vendor has gained access to the facility.

Problems, however, abound with this credentialing process. Credentialing providers traditionally have provided health care organizations with limited different credential categories that all entities (whether they be vendors, devices, etc.) must fit into. For example, FIG. 1 illustrates a prior art credential matrix that is limited to eight different credential levels. (The following acronyms have the following meanings: BGC—background check; GWL—government watch list; PST—product specific training; BBP—blood borne pathogen; MMR—mump-measles-rubella; VAR—varicella; INF—influenza; GHS—general expectations and hospital safety course.) In other words, every entity that desires access to a health care facility would have to be “pigeon-holed” (by the health care organization and the credentialing provider) into one or more of these levels because that was all the prior art credentialing services offered. Once the health care organization chose one of the pre-established credential levels for each entity (and communicated that level to the credentialing provider), the credentialing provider would require the entity to meet the designated requirements for that level before providing the entity a badge, bar code, or other means of gaining authorized access into the health care facility.

These pre-established credential levels were inflexible and proved to be too limiting because they were incapable of encompassing all the various other credential categories (and/or levels within categories) a health care organization might want, need, or desire. Moreover, not all health care organizations are similarly situated in the sense of having the same needs or desiring the same level of flexibility in their credentialing process. For example, while the eight prior art credential levels were designed to accommodate vendors to health care facilities, other/different credential categories might better serve other entities seeking access to the facility, such as volunteers, students, contractors, equipment, etc. Likewise, there exists a need for additional, specific credential categories even within these other/different categories such as, in the case of contractors, credential subcategories for plumbers, electricians, elevator repair, etc. Still further, instead of the limited number of access levels (and their associated criteria) afforded by the prior art for a particular category, there exists a need for unlimited access levels (and corresponding unlimited criteria associated therewith) for all categories and/or subcategories offered. In essence, the need for an entirely new credentialing paradigm exists.

### SUMMARY

The present invention addresses the disadvantages and drawbacks of current credentialing processes and the apparatuses associated therewith.

As an example, the present invention replaces the prior art credentialing process with a customized credentialing process. A customized credentialing process enables credentialing providers to work with clients (such as a health care organization) to create a credential matrix tailored specifically to the client's needs, i.e., one no longer tied to (or limited by) the credentialing provider's pre-ordained credential matrix. Such customized credentials also distinguish over the fixed or otherwise limited credential matrixes in the prior art by providing the credentialing provider and/or the client access to entity data unavailable (and unattainable) in prior art credentialing processes.

Variants of the present invention are possible and within the scope of this disclosure, whether expressly identified or not.

### BRIEF DESCRIPTION OF THE DRAWINGS

The accompanying drawings, which are incorporated herein and constitute a part of the specification, illustrate either the prior art or one or more exemplary embodiments of the present invention. In the drawings:

FIG. 1 is a prior art credential matrix.

### DETAILED DESCRIPTION

The following detailed description does not limit the invention. Instead, the scope of the invention is defined by the appended claims.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” (or variants thereof) in various places throughout the specification is not necessarily referring to the same embodiment. Further, the particular features, structures, or characteristics may be combined in any suitable manner in one or more embodiments.

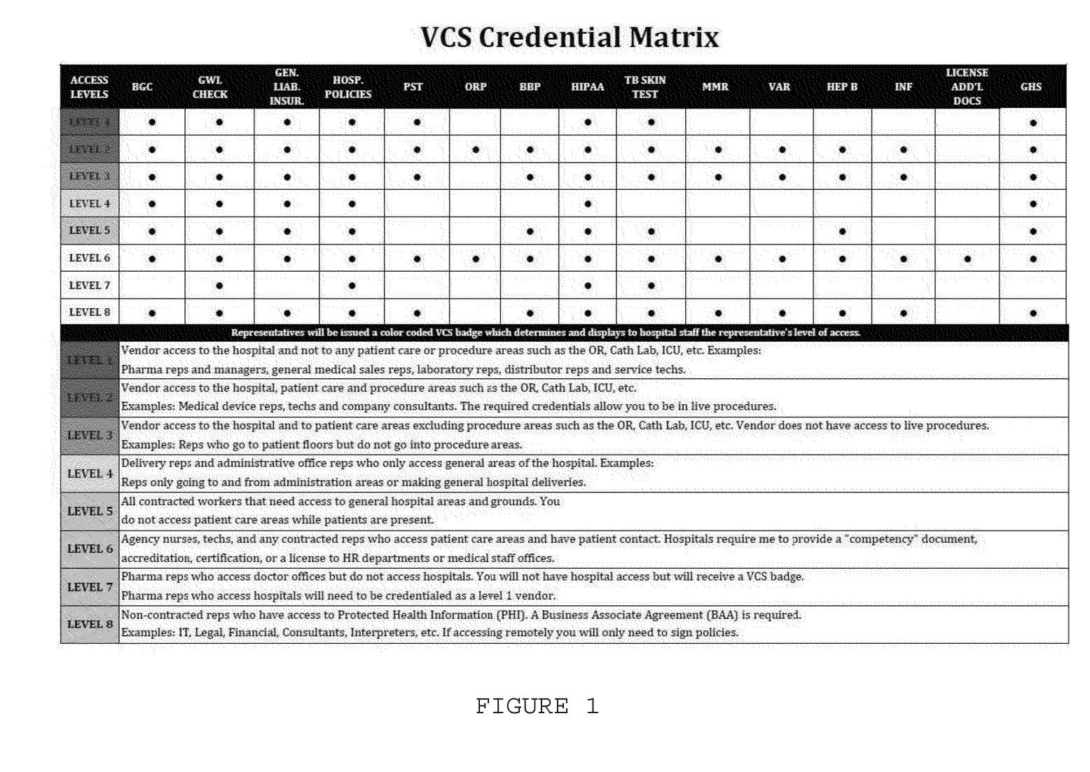

One embodiment of the present invention includes a method of interaction between a credentialing provider and its client. The client can be any entity, organization, or individual that takes advantage of the services offered by the credentialing provider. Whereas the prior art enabled credentialing providers to offer clients a fixed credential matrix such as that shown in FIG. 1, the present invention is not so limited, in that the credentialing provider now can—by taking advantage of the present invention—offer custom credential categories, access levels, and associated criteria, each with their attendant advantages.

A custom credential category comprises an entity or class of entities that are the subject of the credentialing process. The “entity” referred to here can be anyone or anything the client chooses, such as a person, group, organization, species, device, machine, substance, contact, maintenance schedule, or other object (whether animate or inanimate). For example, whereas the prior art provided a category for vendors, the present invention could provide additional, separate categories for volunteers, students, contractors, translators, equipment, devices, etc. The limits of and options for different categories are at the client's choosing.

Each custom credential category may have one or more associated custom credential access levels. For example, whereas the prior art provided eight different access levels, the present invention could provide additional, separate levels up to the number of the client's choosing. Each custom credential access level may comprise criteria designated by the client, where the criteria constitutes the set of requirements the credentialing provider is directed (by the client) to ensure an entity passes before provider “credentials” that entity for that level. The limits and options for different levels and their corresponding criteria are at the client's choosing.

Once the client identifies and communicates (to the credentialing provider) the desired custom credential categories, the number of levels associated with each category, and the criteria for each level, the credentialing provider and each entity (assuming the entity is a person) interact to ensure the entity meets all the designated criteria applicable to that entity. If all the criteria are met, the credentialing provider enables the entity to access the client's facility, as is otherwise known in the art. If all the criteria are not met, the credentialing provider disables the entity from accessing the client's facility, as is otherwise known in the art. (For those instances in which the entity is not a person, the pertinent criteria possessed by that entity are otherwise provided to the credentialing provider by whoever is authorized to act on behalf of the entity.)

In another embodiment, a custom credential category may include a subcategory or subcategories of custom credential categories. As explained above, while the prior art provided a fixed credential matrix for vendors, custom credentialing provided by the present invention now allows credential categories to be attributed to any number of other categories of entities the client chooses, such as credential categories for volunteers, students, contractors, translators, equipment, devices, etc. If the client chooses, each category can include one or more subcategories of entities. For example, if a custom credential category was selected for contractors, one or more custom subcategories of contractors could also be created, such as a subcategory for plumbers, a subcategory for electricians, a subcategory for elevator repair personnel, and so on. As it was for the custom credential categories, the limits of and options for different subcategories are at the client's choosing.

In another embodiment, custom subcategories of entities may have one or more associated custom credential access levels, where each level comprises criteria the client designates as constituting the set of requirements the credentialing provider is directed (by the client) to ensure an entity must pass in order for the entity to be “credentialed” for that level. For example, assume the client created a custom credential category for vendors. The client could then create custom credential subcategories for plumbers, electricians, and elevator repair personnel, where each of those subcategories could include customer credential levels and associated criteria. Note that the custom credential levels and associated criteria are selected by the client and need not be the same across each category or subcategory. In that instance, there would be certain criteria for the access levels in the subcategory of plumbers, other criteria for the access levels in the subcategory of electricians, and still other criteria for the access levels in the subcategory of elevator repair personnel. The client could even allocate a subcategory and an access level therein with its corresponding criteria on a person-by-person basis, so that each person/contractor had his or her own “personalized” credential criteria designated by the client. Still further, each subcategory could have yet another subcategory (with its own corresponding access levels and associated criteria), where the limit of these sub-subcategories is at the client's discretion.

In yet another embodiment, custom credentialing allows the client, credentialing provider, or anyone with access to the custom credentialing data to “mine” that data in ways that were not possible with a prior art fixed credential matrix such as the one shown in FIG. 1. For example, a health care facility could mine its credentialing database to separately identify any or all of its credentialed entities, such as all of its vendors, volunteers, students, contractors, translators, equipment, devices, etc. Likewise, again using the “contractors” category as an example, through the use of subcategories, the credentialing database could be mined to separately identify each credentialed plumber, electrician, elevator repairman, etc.

While simply being able to identify categories or subcategories of credentialed entities in this manner is an advance over the prior art, credentialing using customized categories and subcategories affords still additional advantages. One example is communication. If a credentialing provider or client desires to communicate (via email, phone, text, facsimile, mail, etc.) with one or more categories or subcategories of its credentialed entities, it now can do so since—through use of the present invention—those entities can be identified and distinguished from other credentialed entities, and their associated contact information (relationally stored with each entity's other credential information) can be used to communicate with the entity.

Another example is entity tracking. Since entity data now (as a result of the present invention) can be stored on a category and subcategory basis (all the way down to each individual in a category or subcategory), further relational data can be associated with those categories and subcategories, such as when (i.e., the date and time) an entity enters a health care facility. (In this instance, for example, the present invention logs the day and time an entity scans his or her bar code when gaining access to the facility.) In this case, the facility can mine the relational nature of its credential data to identify every vendor, volunteer, student, etc. who entered the facility on a given day or over a given time period. Likewise, for the case in which the entity is a device that requires periodic maintenance, a maintenance schedule can be relationally associated with that entity's credential data so that such data (1) can be accessed to determine when maintenance is necessary, or (2) to automatically raise an alarm when maintenance is necessary.

While examples of communication and tracking have been provided, other data mining, notification, and other options are possible (as will be appreciated by those skilled in the art) due to the custom credentialing process described above. In that regard, as indicated above, it should be understood that this description is not intended to limit the invention. On the contrary, the exemplary embodiments are intended to cover alternatives, modifications, and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A credentialing method involving a credentialing provider and a client comprising the step of establishing one or more custom credential categories for an entity.

2. The method of claim 1 wherein at least one of the custom credential categories includes one or more custom access levels.

3. The method of claim 2 wherein at least one of the custom access levels includes criteria an entity must satisfy before becoming credentialed.

4. The method of claim 3 including the step of the credentialing provider interacting with the entity (or someone acting on behalf of the entity) to ensure the entity satisfies all the criteria associated with that entity.

5. The method of claim 4 wherein the credentialing provider enables the entity to access a client's facility if all its associated criteria are satisfied.

6. The method of claim 5 wherein the credentialing provider disables the entity from accessing a client's facility if all its associated criteria are not satisfied.

7. The method of claim 6 wherein at least one of the custom credential categories includes a subcategory of custom credential categories for an entity.

8. The method of claim 7 wherein the subcategory of custom credential categories includes one or more custom access levels.

9. The method of claim 8 wherein at least one of the custom access levels for a subcategory includes criteria an entity must satisfy before becoming credentialed.

10. The method of claim 9 wherein the criteria included in a custom access level for a custom credential category is different from the criteria included in a custom access level for another custom credential category.

11. The method of claim 10 wherein the criteria included in a custom access level for a custom credential subcategory is different from the criteria included in a custom access level for another custom credential subcategory.

12. The method of claim 11 wherein the client is an organization or individual that takes advantage of the services offered by the credentialing provider.

13. The method of claim 12 wherein the entity is a person, group, organization, species, device, machine, substance, contact, maintenance schedule, or other object (whether animate or inanimate).

14. A method comprising the steps of populating a database with custom credentialing data and then mining that data to identify one or more credentialed entities.

15. The method of claim 14 further comprising the step of mining said data to communicate with one or more credentialed entities.

16. The method of claim 14 further comprising the step of mining said data to track one or more credentialed entities.
